(19) United States
(12) Patent Application Publication
(10) Pub. No.: US 2009/0278915 A1
(43) Pub. Date: Nov. 12, 2009

(54) Gesture-Based Control System For Vehicle Interfaces

(75) Inventors: Kwindla Hultman Kramer, Los Angeles, CA (US); John S. Underkoffler, Los Angeles, CA (US)

Correspondence Address: COURTNEY STANIFORD & GREGORY LLP, 10001 N. De Anza Blvd., Suite 300, Cupertino, CA, 95014, US

(73) Assignee: Oblong Industries, Inc., Los Angeles, CA (US)

(21) Appl. No.: 12/487,623

(22) Filed: Jun. 18, 2009

Related U.S. Application Data
(63) Continuation-in-part of application No. 11/350,697, filed on Feb. 8, 2006.
Application No. 11/350,697 is a continuation-in-part of application No. 12/109,263, filed on Apr. 24, 2008.
(60) Provisional application No. 61/073,740, filed on Jun. 18, 2008.

(51) Int. Cl. H04N 13/02; G06F 3/033; H04N 7/18

(52) U.S. Cl. 348/48; 715/863; 348/143; 345/158; 348/E13.074; 348/E07.085

(57) ABSTRACT

Systems and method for controlling vehicle subsystems using gestures are described. The controlling comprises receiving an image of an object via sensors in a vehicle and outputting gesture data representing a gesture made by the object. The object comprises at least one hand and/or finger of a user. The gesture data is an instantaneous state of the object at a point in time in space. The controlling comprises automatically detecting the gesture of the object from the gesture data by extracting positions of the object, recovering quantized poses and orientation vectors of the object, and translating the gesture data to a gesture signal. The controlling comprises managing user interactions with the vehicle subsystems in response to the gesture signal.

### RELATED APPLICATION

This application claims the benefit of United States (US) Patent Application No. 61/073,740, filed Jun. 18, 2008.

This patent application is a continuation in part of U.S. patent application Ser. No. 11/350,697, filed Feb. 8, 2006, and published as US Patent Application Publication US 2006/0187196 A1, which claims priority to U.S. Patent Application No. 60/651,290, filed Feb. 8, 2005.

This application is a continuation in part of U.S. patent application Ser. No. 12/109,263, filed Apr. 24, 2008.

### FIELD OF THE INVENTION

This invention relates to the field of computer systems in general and in particular to gesture-based control systems and methods for vehicle interfaces.

### BACKGROUND

Conventional control systems and user interfaces facilitating human-computer interaction have numerous deficiencies.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1A is a block diagram of a gestural control system, under an embodiment.

FIG. 1B is a block diagram of a gestural control system integrated with vehicular subsystems, under an embodiment.

FIG. 1C is a block diagram of a controller, under an embodiment.

FIG. 1D is a flow diagram for controlling vehicle subsystems using gestures, under an embodiment.

FIG. 2 is a diagram of marking tags, under an embodiment.

FIG. 3 is a diagram of poses in a gesture vocabulary, under an embodiment.

FIG. 4 is a diagram of orientation in a gesture vocabulary, under an embodiment.

FIG. 5 is a diagram of two hand combinations in a gesture vocabulary, under an embodiment.

FIG. 6 is a diagram of orientation blends in a gesture vocabulary, under an embodiment.

FIG. 7 is a flow diagram of system operation, under an embodiment.

FIGS. 8/1 and 8/2 shows example commands, under an embodiment.

### DETAILED DESCRIPTION

Systems and methods are described herein for gesture-based control of subsystems. Embodiments of the systems and methods are provided in the context of a Spatial Operating Environment (SOE), described in detail below. The SOE, which includes a gestural control system, or gesture-based control system, can alternatively be referred to as a Spatial User Interface (SUI) or a Spatial Interface (SI).

In the following description, a number of features are described in detail in order to provide a more thorough understanding of the embodiments. It is apparent that the embodiments may be practiced without these specific details. In other cases, well known features have not been described in detail.

### System

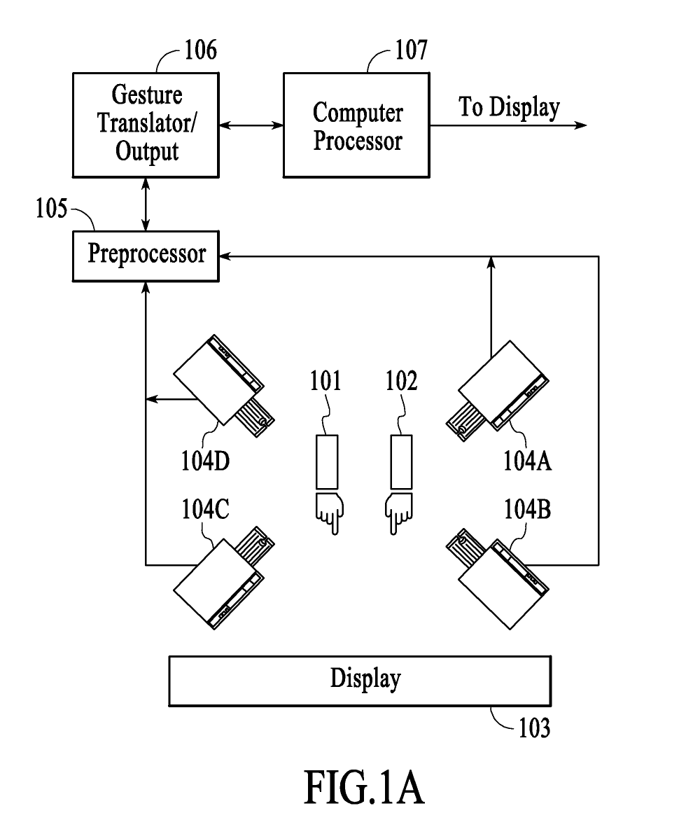

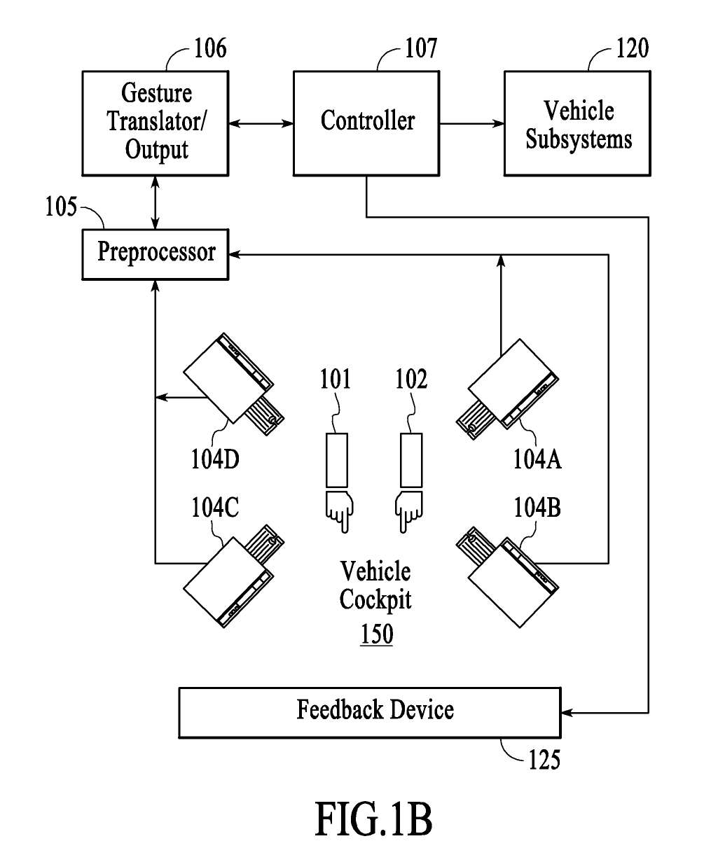

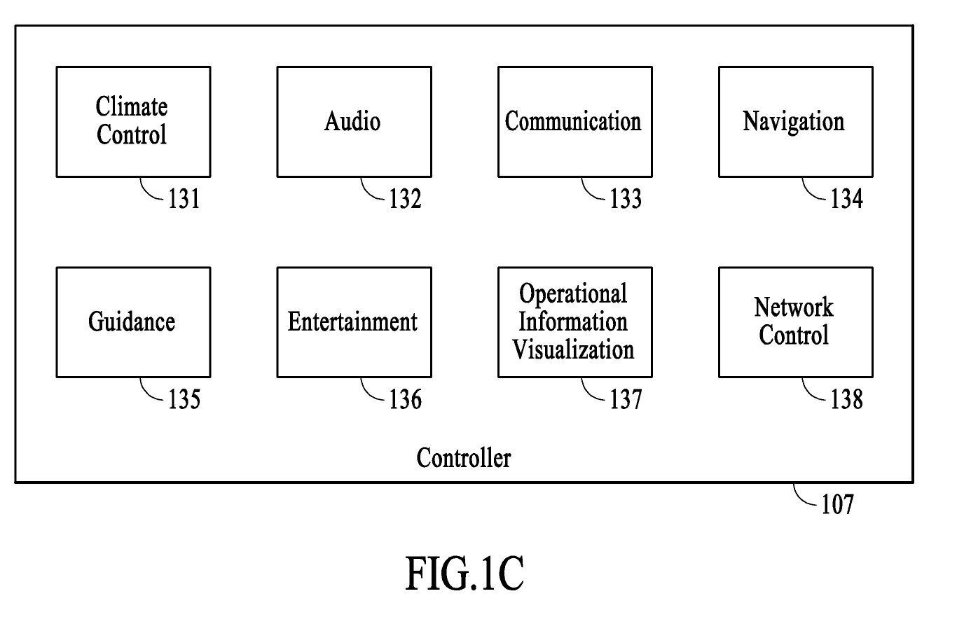

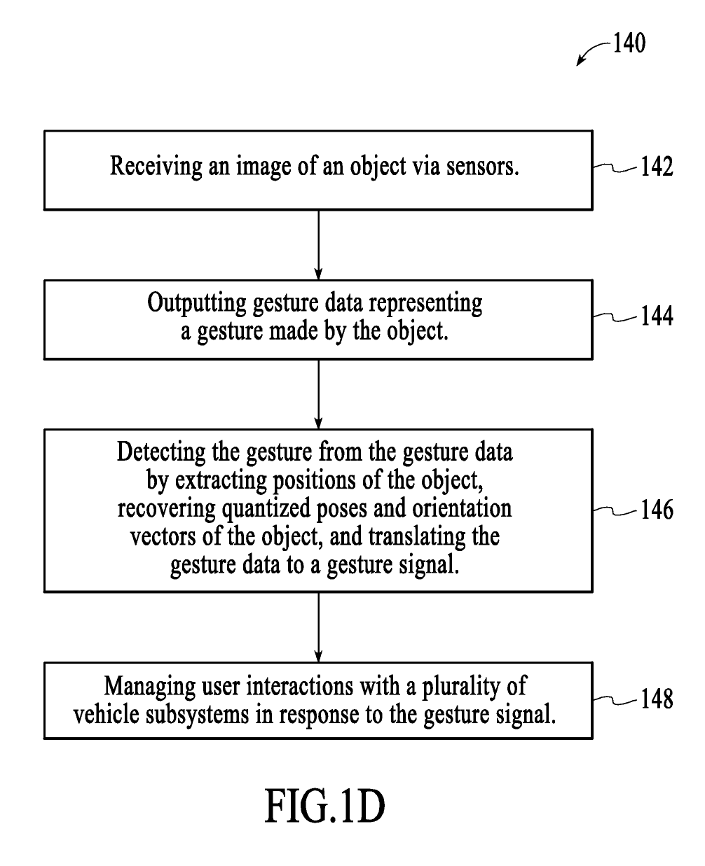

Embodiments of a gesture-based control system are described herein in the context of a Spatial Operating Environment (SOE). As an example, FIG. 1A is a block diagram of a Spatial Operating Environment (SOE), under an embodiment. A user locates his hands 101 and 102 in the viewing area 150 of an array of cameras 104A-104D. The cameras detect location, orientation, and movement of the fingers and hands 101 and 102 and generate output signals to pre-processor 105. Pre-processor 105 translates the camera output into a gesture signal that is provided to the computer processing unit 107 of the system. The computer 107 uses the input information to generate a command to control one or more on screen cursors and provides video output to display 103.

Although the system is shown with a single user's hands as input, the embodiment can also be implemented using multiple users. In addition, instead of or in addition to hands, the system may track any part or parts of a user's body, including head, feet, legs, arms, elbows, knees, and the like.

In the embodiment shown, four cameras are used to detect the location, orientation, and movement of the user's hands 101 and 102. It should be understood that the embodiment may be used with more (e.g., six cameras, eight cameras, etc.) or fewer cameras (e.g., two cameras) without departing from the scope or spirit of the embodiment. In addition, although the cameras are disposed symmetrically in the example embodiment, there is no requirement of such symmetry. Any number or positioning of cameras that permits the location, orientation, and movement of the user's hands may be used.

In one embodiment, the cameras used are motion capture cameras capable of capturing grey-scale images. In one embodiment, the cameras used are those manufactured by Vicon, such as the Vicon MX40 camera. This camera includes on-camera processing and is capable of image capture at 1000 frames per second. A motion capture camera is capable of detecting and locating markers.

In the embodiment described, the cameras are used for optical detection. In other embodiments, the cameras or other detectors may be used for electromagnetic, magnetostatic, RFID, or any other suitable type of detection.

Pre-processor 105 is used to generate three dimensional space point reconstruction and skeletal point labeling. The gesture translator 106 is used to convert the 3D spatial information and marker motion information into a command language that can be interpreted by a computer processor to update the location, shape, and action of a cursor on a display. In an alternate embodiment, the pre-processor 105 and gesture translator 106 can be combined into a single device.

Computer 107 may be any general purpose computer such as manufactured by Apple, Dell, or any other suitable manufacturer. The computer 107 runs applications and provides display output. Cursor information that would otherwise come from a mouse or other prior art input device now comes from the gesture system.

Gestural Control System Integrated with Vehicle Interfaces

FIG. 1B is a block diagram of a gestural control system integrated with vehicular subsystems 120, under an embodiment. A person in the cockpit area or other passenger compartment area of a vehicle (e.g., automobile, tractor, aircraft, etc.) can control the vehicle subsystems 120 using objects that includes one or both of the user's hands 101 and 102 and a set of fingers of one or both of the hands 101 and 102. The cockpit area of the vehicle is the viewing area of an array of cameras 104A-104D. The cameras detect location, orientation, and movement of objects (e.g., hands 101 and 102 and fingers of the hands) and generate output signals to pre-processor 105. Pre-processor 105 translates the camera output into a gesture signal that is provided to the controller 107 (also referred to herein as computer processing unit 107 or computer 107) of the system. The controller 107 uses the input information to generate a command to control one or more vehicular subsystems 120.

The controller 107 of an embodiment includes one or more control programs to manage the user interactions with the automotive subsystem elements that are exposed via the interactive system. FIG. 1C is a block diagram of a controller 107, under an embodiment. This controller 107, as one example, includes climate control 131, audio 132, communication 133, navigation 134, guidance 135, entertainment 136, operational information visualization 137, and network control 138 programs or applications for gestural control of corresponding automotive subsystem elements, but is not limited to these control programs. The control programs included in a controller of a vehicle correspond to the vehicle subsystems available for control in the vehicle.

Although the system is shown with a single user's hands and/or fingers as the tracked object, the embodiment may also be implemented using multiple users. Furthermore, instead of or in addition to hands, the system may track objects including one or more of any part or parts of a user's body, including head, feet, legs, arms, elbows, knees, and the like.

In the embodiment shown, four cameras are used to detect the location, orientation, and movement of the user's hands 101 and 102. It should be understood that the embodiment may be used with more (e.g., six cameras, eight cameras, etc.) or fewer cameras (e.g., two cameras) without departing from the scope or spirit of the embodiment. In addition, although the cameras are disposed symmetrically in the example embodiment, there is no requirement of such symmetry. Any number or positioning of cameras that permits the location, orientation, and movement of the user's hands may be used.

Pre-processor 105 generates three-dimensional space point reconstruction and skeletal point labeling. The gesture translator 106 converts the 3D spatial information and object motion information into a command language that can be interpreted by a computer processor to control a vehicular subsystem. In an alternate embodiment, the pre-processor 105 and gesture translator 106 can be combined into a single device.

Embodiments of the gestural control system integrated with vehicular subsystems enable a driver or passenger in a vehicle to control vehicle subsystem control elements, and one or more parameters of the vehicle subsystem, using gestures. The user therefore can control one or more parameters of a vehicle subsystem like, for example, piloting, navigational, and peripheral system functions by means of a gesturally-driven interface. The gesture control system described herein integrates with one or more vehicular subsystems 120 including, but not limited to, interactive navigation devices, radio and digital audio players, telephones, cruise control, autopilot and other automated guidance modules, climate control, operational information visualizations, and networked applications to name a few.

The gestural control system described herein includes a feedback device 125 that provides various types of feedback to the user, including but not limited to audio cues, visual output on a head-up display, visual output on dash and panel-mounted pixel-based displays, special-purpose lighted or color-changing indicators, and haptic or tactile displays to name a few. While the feedback device 125 is shown coupled to the controller 107, the embodiment is not so limited, and the feedback device 125 could be coupled to any other component of the integrated system.

FIG. 1D is a flow diagram for controlling 140 vehicle subsystems using gestures, under an embodiment. The embodiment comprises receiving 142 an image of an object via a plurality of sensors in a vehicle and outputting 144 gesture data representing a gesture made by the object. The object comprises at least one of a hand and a finger of a user. The gesture data is an instantaneous state of the object at a point in time in space. The embodiment comprises automatically detecting 146 the gesture of the object from the gesture data by extracting positions of the object, recovering quantized poses and orientation vectors of the object, and translating the gesture data to a gesture signal. The embodiment comprises managing 148 user interactions with a plurality of vehicle subsystems in response to the gesture signal.

The gestural control system of an embodiment may be configured in several different ways. The systems and methods of an embodiment involve two distinct types of gestural control: minimal motions of one or several fingers in close proximity to a particular physical object; and free-space movement involving the entire hand. These are, of course, idealized categories. In practice, a particular configuration may blur the distinction between the two kinds of gestural control system.

The following description of the gestural control system integrated with vehicular subsystems is articulated with occasional reference to the particulars of an automotive context, but it should be understood that the system described is fully general and may be employed for interactive control of functions associated with any vehicle type.

The gestural control system for vehicle interfaces of an embodiment includes one or more of the following: a set of sensors for tracking finger and/or whole-hand positions in three-dimensional space; applications or components for processing the sensor data; representational elements for representing the finger and/or hand positions in a form that can be used by control programs or other vehicle-based programs or applications; control programs to manage the user interactions with automotive subsystem elements that are exposed via the interactive system; and/or a feedback scheme including continuous and/or dynamic feedback through visual and other channels by which human operators are apprised not only of the gestural control system's effect on automotive subsystem elements but also of the gestural control system's instantaneous, ongoing, and predictive interpretation of the operator's relevant hand pose and motions. While the gestural control system for vehicle interfaces does not contemplate the use of markers, described below, embodiments are not so limited.

The sensors of an embodiment can take various forms. An embodiment uses two or more small cameras coupled together to form a stereo vision system. The cameras are positioned to view a cockpit and/or passenger compartment of a host vehicle. This stereo vision system generates, at minimum, a three-dimensional data point cloud for objects within its field of view. The resolved depth accuracy of the points in the data set varies according to a number of factors, including distance from the camera baseline, but is approximately 1 millimeter (mm). The objects imaged are the bare hand(s) and/or finger(s) of a user or operator.

The sensors of an alternative embodiment are time-of-flight depth-sensing cameras. The sensors of another alternative embodiment are structured light three-dimensional sensors.

Given a point cloud generated by the stereo sensor set, the gestural control system extracts positions of at least one of a hand and a finger, from which in turn quantized hand poses and continuous hand and finger orientation vectors may be recovered. The approach used for this recovery is substantially similar to the methods described below except the vehicular system starts with unstructured point clouds, rather than aggregate-tagged data. The hand and finger representations are made available to the mechanisms that implement the system's interactive modes.

Embodiments use multiple sets of stereo-coupled cameras, or use modified correlation algorithms that process pixel data to handle more than one camera. Increasing the number of cameras can, for example, expand the field of view, decrease difficulties posed by occlusion of parts of the hands, and/or increase the accuracy of point cloud data.

Under a first interactive mode of the gestural control system, the driver of a vehicle controls the various subsystems with finger motions while keeping her hands in contact with or very close to a steering wheel or other vehicle guidance mechanism. This steering-wheel-centric mode includes or uses precise tracking of the position of a subset of fingers on each of the driver's hands.

The driver begins with a normal grip on the steering wheel with, for example, hands in the ten o'clock and two o'clock positions and fingers wrapped around the wheel rim. Extending any of the index and middle fingers of either hand activates the control system. Various combinations of finger movements allow navigation through and selection of various control modes, elements and/or parameters of the vehicle subsystems. An alternative scheme implicates tracked motion of the user's thumbs instead of, or in addition to, the index and middle fingers.

Simple systems control (e.g., vehicle systems) can be achieved by sequentially stepping through available modes combined with “plus/minus” state changes. A sample configuration of finger-control state space includes extending both fingers on either hand to activate the control system, and a quick grip-and-extend-again flick of those two fingers rotates through the major control modes available (e.g., radio, telephone, digital audio player, climate control, etc.). The other hand then steps through and controls the available options within that mode. The quick two-finger grip-and-extend configuration cycles through major setting modes of a coupled system. Stepping of the parameters of an individual setting up and down is provided by single-finger grip-and-extend flick or hold-down movements of, respectively, the index and middle fingers. Analogous operations allow the traversal of sub-modes, sub-sub-modes, etc., in cases in which the control topology is more than a single level deep.

So, in the radio mode for example, the initial setting mode is the volume control. A quick grip-and-extend of the index finger raises the volume setting by one increment. Conversely, a grip-and-extend of the middle finger lowers the volume one increment. Holding either finger down on the wheel (with the other finger remaining outstretched) raises or lowers the volume at a constant rate. A two-finger grip-and-extend cycles to the next setting mode, the radio presets. Here again the up and down traversal of the presets list is controlled by index and middle finger movement.

The relatively simple mapping of finger movements to control inputs described herein has several desirable properties. Much of the interactive model is based directly on familiar vehicular interfaces, for example, the up/down buttons found on nearly every car radio.

The gestural control system can be coupled to numerous available output devices to provide feedback to the user. For example, an output of the gestural control system includes synthesized speech feedback relating to a gesture or control effected by a gesture. As another example, an output of the gestural control system includes large text on a basic alpha-numeric display. Additionally, an output comprising hard-molded, binary lighted button displays or masked LCD screens can be provided.

Use of the gestural control system reduces the need to move the hands away from the steering wheel or to modify the normal driving hand positions and postures. These driving-friendly ergonomics provide comfort and simplicity, and may be desirable for safety.

If a full graphical display is present and coupled to the gestural control system, an additional set of interactive behaviors becomes available. Finger movement can drive the position of a pointer cursor on a graphical display, which in turn allows non-linear selection of control modes and settings. In an embodiment, this graphical display is integrated into the windshield (e.g., in a head-up configuration in which implicit optical power presents the display at a depth optimized for ocular accommodation) or mounted in the dashboard assembly directly above and behind the steering wheel. Such a configuration puts the graphical display within the driver's direct field of normal, “over the steering wheel” view.

For this non-linear control style, the hands begin in a normal driving position. Extending the index finger on either hand activates the control system and displays a pointing cursor on the display. Relative movement of the tip of the finger drives the horizontal and vertical movement of the cursor over the display area. Interface graphics on the display can be selected by pointer proximity, and manipulated by the one- and two-finger clicks and holds of the non-pointer hand, or by the two-dimensional finger tip movement of the index finger on the non-pointer hand. A simple (virtual) toggle button can be controlled by an index finger grip-and-extend. A virtual scale or slider—for example a volume control—can be controlled by the index and middle fingers as described above.

A second interactive mode of the gestural control system involves free-space control. In this mode the user (e.g., vehicle operator or a passenger) interacts with the navigation system, radio, and/or other subsystem by moving one of her hands and articulating the fingers within a particular open area of the car's interior. Free-space control can be used in conjunction with a fully graphical display, where an embodiment can position the sensing volume, and thus the operator's actions, directly in front of the display.

In an embodiment, a “mime gun” pose, pointed at the display, activates the control system. Ten poses, along with transitions between them and permuted with fine-grained aim and motion of the hand, constitute the core gestural vocabulary of an embodiment. The gestural vocabulary, however, is not limited to ten poses. The ten poses of an embodiment are generated by way of combinatorics: the ‘barrel’ of a ‘mime gun’ can be formed either by the index finger alone or by the index and middle fingers together. For either of these two states, the thumb may be either perpendicular to the ‘barrel’ (in the plane of the hand) or may be ‘clicked’ down, parallel to the ‘barrel’. Further, for each of these four states the entire hand-plus-fingers geometry may be oriented either vertically, in a gravity-aligned plane, or horizontally, in a gravity-perpendicular plane. This gives eight fundamental poses; two additional poses are formed by rotating the hand mass so that the ‘barrel’ is pointing substantially medially.

The ten poses of an embodiment are expressed in the gestural description language (described in detail below) according to the following:

̂̂̂|-:-x (‘one finger point’)

̂̂̂∥:-x (‘one finger click’)

̂̂∥-:-x (‘two finger point’)

̂̂|∥:-x (‘two finger click’)

̂̂̂|-:vx (‘prone one finger point’)

̂̂̂∥:vx (‘prone one finger click’)

̂̂∥-:vx (‘prone two finger point’)

̂̂|∥:vx (‘prone two finger click’)

̂̂̂|-:.- (‘medial one finger point’)

̂̂∥-:.- (‘medial two finger point’).

The poses and gestural description language provided here are but one example used in the gestural control system, and numerous other examples and combinations are possible, some of which are described below.

The gestural control system of an embodiment presents, using a graphical display or other feedback device, a set of menu elements, selection elements, and pan and zoom capabilities. Navigation through the system is consistent from high-level selection of target subsystem down to manipulation of individual selection elements.

With the control system active (following the first recovery of a vertical, thumb-up, one-finger point), a pointing cursor and contextual menu elements for the current mode appear. The cursor position is driven by the movement and/or aim of the index finger. Basic selection and control over button, slider, and menu elements is accomplished by positioning the pointer within an element and moving the thumb to the down/click (aligned with index finger) position. Moving the cursor off the screen to the medial side brings up a high-level menu list, with cursor movement constrained to two dimensions (up and down). Selecting an option from the high-level menu acts to change control modes (for example, from the telephone to the navigation system).

Modes of the host vehicle system can make use of true three-dimensional movement of the hand. While within the navigation system mode, for example, tipping the hand over into the thumb-horizontal pose renders the normal selection elements translucent and ties the position and zoom of the map to the left, right, up, down, forward, and back movements of the hand. Returning to a thumb-vertical pose freezes the map view and restores the contextual menu and selection elements.

Many refinements are possible for operators who achieve a minimal level of comfort and familiarity with the basic system. For example, the two-finger poses enumerated above can be selectively tied to particular “short-cut” functions. A driver may choose to associate common radio functions—volume control and station presets, say—to the two-finger poses, so that these control modes are always available. With this customization activated, no interactive context switch is necessary to manipulate the radio; such control actions may thus occur ‘out of band’ from other ongoing control sequences. That is (for the present example): one-finger poses act as described above; two-finger poses directly and instantaneously enact the radio short-cuts and associated feedback graphics, which latter then disappear when the active hand leaves the control space or returns to one-finger poses associated with ‘standard’ control semantics. The various interactions described herein can be combined to form a potentially immense set of control and interface behaviors, as described in more detail below.

### Marker Tags

In contrast to the systems and methods described above, the systems and methods of an embodiment can use marker tags on one or more fingers of the user so that the system can locate the hands of the user, identify whether it is viewing a left or right hand, and which fingers are visible. This permits the system to detect the location, orientation, and movement of the user's hands. This information allows a number of gestures to be recognized by the system and used as commands by the user.

The marker tags in one embodiment are physical tags comprising a substrate (appropriate in the present embodiment for affixing to various locations on a human hand) and discrete markers arranged on the substrate's surface in unique identifying patterns.

The markers and the associated external sensing system may operate in any domain (e.g., optical, electromagnetic, magnetostatic, etc.) that allows the accurate, precise, and rapid and continuous acquisition of their three-space position. The markers themselves may operate either actively (e.g. by emitting structured electromagnetic pulses) or passively (e.g. by being optically retroreflective, as in the present embodiment).

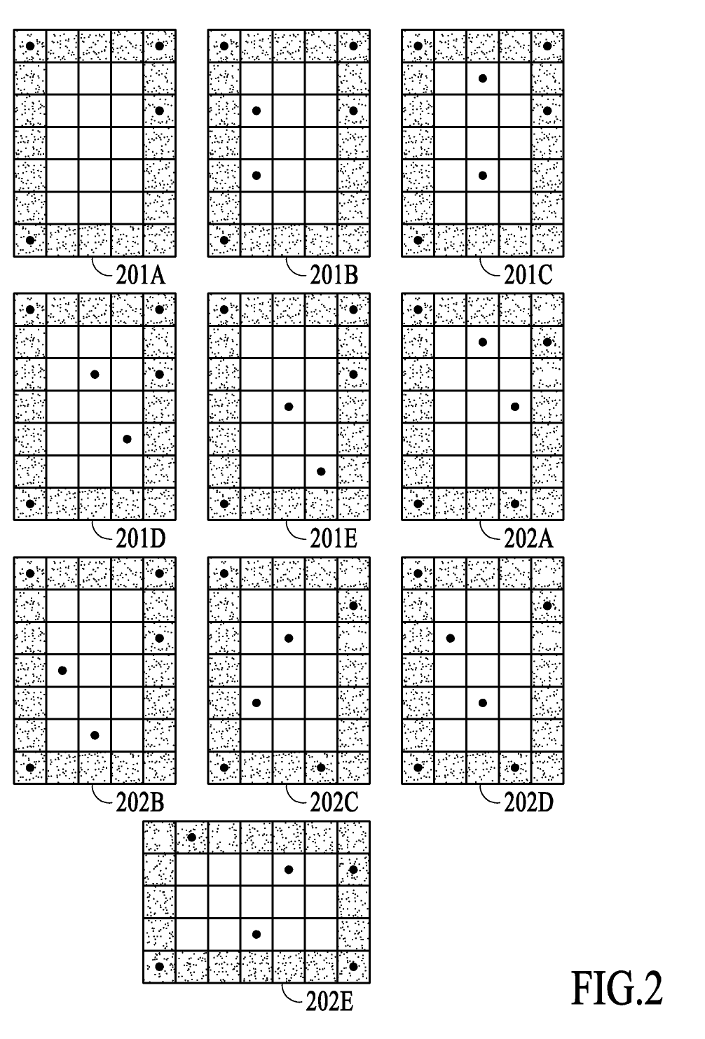

At each frame of acquisition, the detection system receives the aggregate cloud of recovered three-space locations comprising all markers from tags presently in the instrumented workspace volume (within the visible range of the cameras or other detectors). The markers on each tag are of sufficient multiplicity and are arranged in unique patterns such that the detection system can perform the following tasks: (1) segmentation, in which each recovered marker position is assigned to one and only one subcollection of points that form a single tag; (2) labeling, in which each segmented subcollection of points is identified as a particular tag; (3) location, in which the three-space position of the identified tag is recovered; and (4) orientation, in which the three-space orientation of the identified tag is recovered. Tasks (1) and (2) are made possible through the specific nature of the marker-patterns, as described below and as illustrated in one embodiment in FIG. 2.

The markers on the tags in one embodiment are affixed at a subset of regular grid locations. This underlying grid may, as in the present embodiment, be of the traditional Cartesian sort; or may instead be some other regular plane tessellation (a triangular/hexagonal tiling arrangement, for example). The scale and spacing of the grid is established with respect to the known spatial resolution of the marker-sensing system, so that adjacent grid locations are not likely to be confused. Selection of marker patterns for all tags should satisfy the following constraint: no tag's pattern shall coincide with that of any other tag's pattern through any combination of rotation, translation, or mirroring. The multiplicity and arrangement of markers may further be chosen so that loss (or occlusion) of some specified number of component markers is tolerated: After any arbitrary transformation, it should still be unlikely to confuse the compromised module with any other.

Referring now to FIG. 2, a number of tags 201A-201E (left hand) and 202A-202E (right hand) are shown. Each tag is rectangular and consists in this embodiment of a 5×7 grid array. The rectangular shape is chosen as an aid in determining orientation of the tag and to reduce the likelihood of mirror duplicates. In the embodiment shown, there are tags for each finger on each hand. In some embodiments, it may be adequate to use one, two, three, or four tags per hand. Each tag has a border of a different grey-scale or color shade. Within this border is a 3×5 grid array. Markers (represented by the black dots of FIG. 2) are disposed at certain points in the grid array to provide information.

Qualifying information may be encoded in the tags' marker patterns through segmentation of each pattern into ‘common’ and ‘unique’ subpatterns. For example, the present embodiment specifies two possible ‘border patterns’, distributions of markers about a rectangular boundary. A ‘family’ of tags is thus established—the tags intended for the left hand might thus all use the same border pattern as shown in tags 201A-201E while those attached to the right hand's fingers could be assigned a different pattern as shown in tags 202A-202E. This subpattern is chosen so that in all orientations of the tags, the left pattern can be distinguished from the right pattern. In the example illustrated, the left hand pattern includes a marker in each corner and on marker in a second from corner grid location. The right hand pattern has markers in only two corners and two markers in non corner grid locations. An inspection of the pattern reveals that as long as any three of the four markers are visible, the left hand pattern can be positively distinguished from the left hand pattern. In one embodiment, the color or shade of the border can also be used as an indicator of handedness.

Each tag must of course still employ a unique interior pattern, the markers distributed within its family's common border. In the embodiment shown, it has been found that two markers in the interior grid array are sufficient to uniquely identify each of the ten fingers with no duplication due to rotation or orientation of the fingers. Even if one of the markers is occluded, the combination of the pattern and the handedness of the tag yields a unique identifier.

In the present embodiment, the grid locations are visually present on the rigid substrate as an aid to the (manual) task of affixing each retroreflective marker at its intended location. These grids and the intended marker locations are literally printed via color inkjet printer onto the substrate, which here is a sheet of (initially) flexible ‘shrink-film’. Each module is cut from the sheet and then oven-baked, during which thermal treatment each module undergoes a precise and repeatable shrinkage. For a brief interval following this procedure, the cooling tag may be shaped slightly—to follow the longitudinal curve of a finger, for example; thereafter, the substrate is suitably rigid, and markers may be affixed at the indicated grid points.

In one embodiment, the markers themselves are three dimensional, such as small reflective spheres affixed to the substrate via adhesive or some other appropriate means. The three-dimensional markers can be an aid in detection and location over two dimensional markers. However either can be used without departing from the spirit and scope of the embodiment.

At present, tags are affixed via Velcro or other appropriate means to a glove worn by the operator or are alternately affixed directly to the operator's fingers using a mild double-stick tape. In a third embodiment, it is possible to dispense altogether with the rigid substrate and affix—or ‘paint’—individual markers directly onto the operator's fingers and hands.

### Gesture Vocabulary

The embodiment contemplates a gesture vocabulary consisting of hand poses, orientation, hand combinations, and orientation blends. A notation language is also implemented for designing and communicating poses and gestures in the gesture vocabulary of the embodiment. The gesture vocabulary is a system for representing instantaneous ‘pose states’ of kinematic linkages in compact textual form. The linkages in question may be biological (a human hand, for example; or an entire human body; or a grasshopper leg; or the articulated spine of a lemur) or may instead be nonbiological (e.g. a robotic arm). In any case, the linkage may be simple (the spine) or branching (the hand). The gesture vocabulary system of the embodiment establishes for any specific linkage a constant length string; the aggregate of the specific ASCII characters occupying the string's ‘character locations’ is then a unique description of the instantaneous state, or ‘pose’, of the linkage.

### Hand Poses

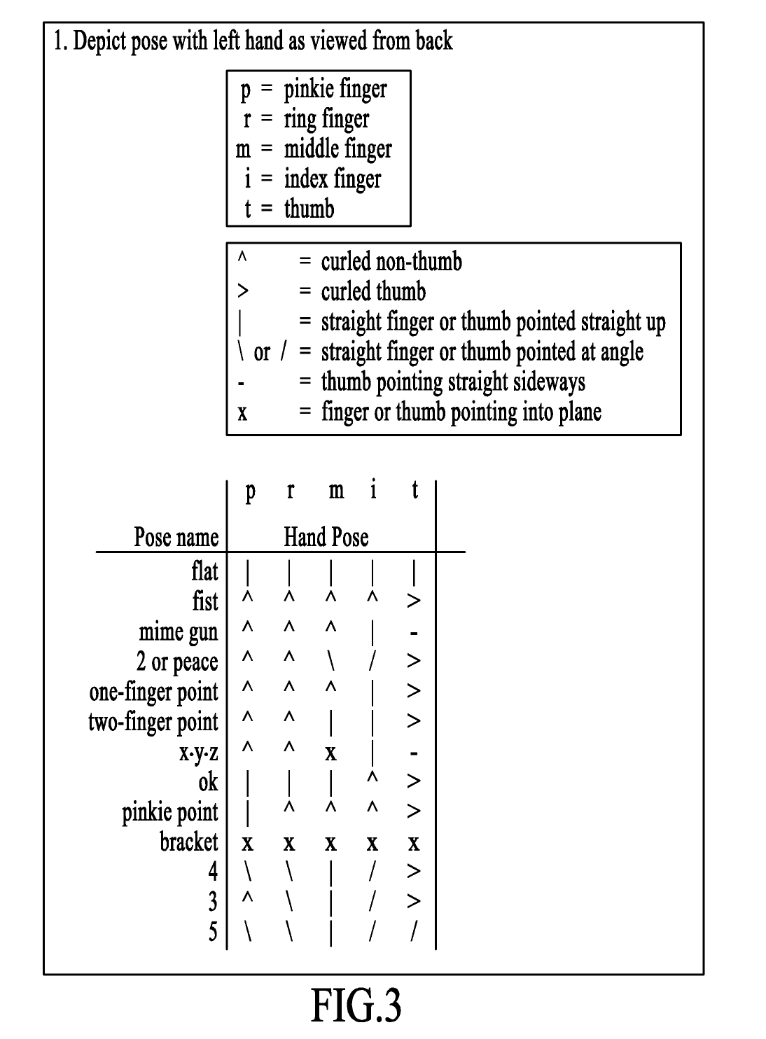

FIG. 3 illustrates hand poses in an embodiment of a gesture vocabulary. The embodiment supposes that each of the five fingers on a hand are used. These fingers are codes as p-pinkie, r-ring finger, m-middle finger, i-index finger, and t-thumb. A number of poses for the fingers and thumbs are defined and illustrated in FIG. 3. A gesture vocabulary string establishes a single character position for each expressible degree of freedom in the linkage (in this case, a finger). Further, each such degree of freedom is understood to be discretized (or ‘quantized’), so that its full range of motion can be expressed through assignment of one of a finite number of standard ASCII characters at that string position. These degrees of freedom are expressed with respect to a body-specific origin and coordinate system (the back of the hand, the center of the grasshopper's body; the base of the robotic arm; etc.). A small number of additional gesture vocabulary character positions are therefore used to express the position and orientation of the linkage ‘as a whole’ in the more global coordinate system.

Still referring to FIG. 3, a number of poses are defined and identified using ASCII characters. Some of the poses are divided between thumb and non-thumb. The embodiment uses a coding such that the ASCII character itself is suggestive of the pose. However, any character may used to represent a pose, whether suggestive or not. In addition, there is no requirement to use ASCII characters for the notation strings. Any suitable symbol, numeral, or other representation maybe used without departing from the scope and spirit of the embodiment. For example, the notation may use two bits per finger if desired or some other number of bits as desired.

A curled finger is represented by the character “̂” while a curled thumb by “>”. A straight finger or thumb pointing up is indicated by “1” and at an angle by “\” or “/”. “-” represents a thumb pointing straight sideways and “x” represents a thumb pointing into the plane.

Using these individual finger and thumb descriptions, a robust number of hand poses can be defined and written under an embodiment. Each pose is represented by five characters with the order being p-r-m-i-t as described above. FIG. 3 illustrates a number of poses and a few are described here by way of illustration and example. The hand held flat and parallel to the ground is represented by “11111”. A fist is represented by “̂̂̂̂>”. An “OK” sign is represented by “111̂>”.

The character strings provide the opportunity for straightforward ‘human readability’ when using suggestive characters. The set of possible characters that describe each degree of freedom may generally be chosen with an eye to quick recognition and evident analogy. For example, a vertical bar (‘|’) would likely mean that a linkage element is ‘straight’, an ell (“L”) might mean a ninety-degree bend, and a circumflex (‘̂’) could indicate a sharp bend. As noted above, any characters or coding may be used as desired.

Any system employing gesture vocabulary strings such as described herein enjoys the benefit of the high computational efficiency of string comparison—identification of or search for any specified pose literally becomes a ‘string compare’ (e.g. UNIX's ‘strcmp( )’ function) between the desired pose string and the instantaneous actual string. Furthermore, the use of wildcard characters' provides the programmer or system designer with additional familiar efficiency and efficacy: degrees of freedom whose instantaneous state is irrelevant for a match may be specified as an interrogation point (‘?’); additional wildcard meanings may be assigned.

### Orientation

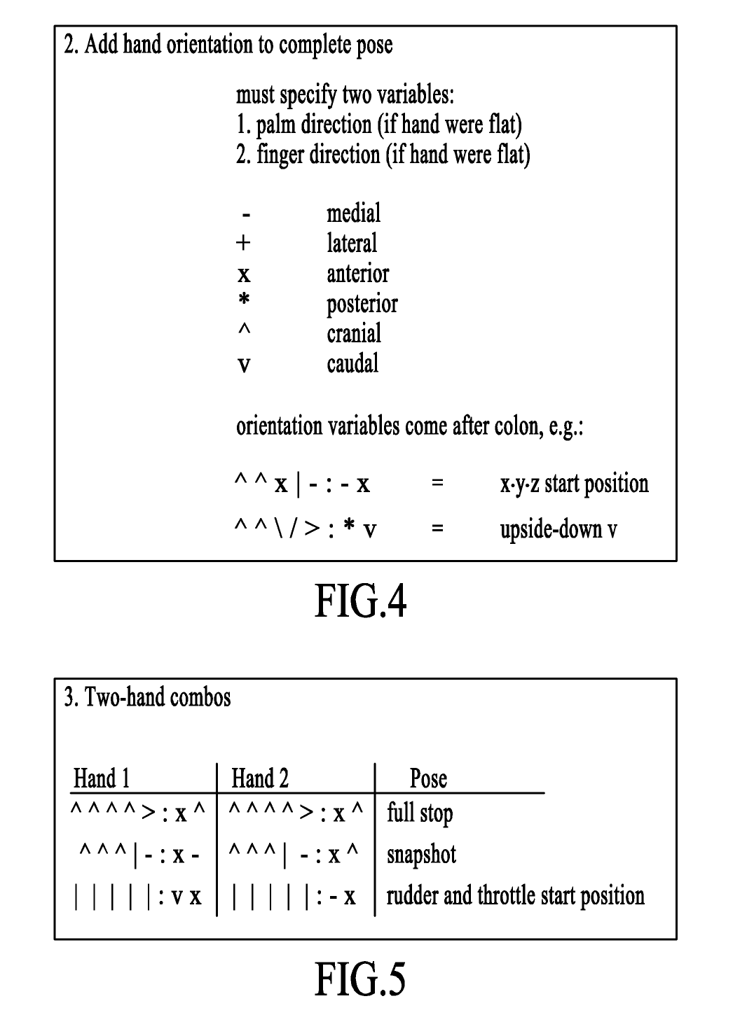

In addition to the pose of the fingers and thumb, the orientation of the hand can represent information. Characters describing global-space orientations can also be chosen transparently: the characters ‘<’, ‘>’, ‘̂’, and ‘v’ may be used to indicate, when encountered in an orientation character position, the ideas of left, right, up, and down. FIG. 4 illustrates hand orientation descriptors and examples of coding that combines pose and orientation. In an embodiment, two character positions specify first the direction of the palm and then the direction of the fingers (if they were straight, irrespective of the fingers' actual bends). The possible characters for these two positions express a ‘body-centric’ notion of orientation: ‘-’, ‘+’, ‘x’, ‘*’, ‘̂’, and ‘v’ describe medial, lateral, anterior (forward, away from body), posterior (backward, away from body), cranial (upward), and caudal (downward).

In the notation scheme of an embodiment, the five finger pose indicating characters are followed by a colon and then two orientation characters to define a complete command pose. In one embodiment, a start position is referred to as an “xyz” pose where the thumb is pointing straight up, the index finger is pointing forward and the middle finger is perpendicular to the index finger, pointing to the left when the pose is made with the right hand. This is represented by the string “̂̂x1-:-x”.

‘XYZ-hand’ is a technique for exploiting the geometry of the human hand to allow full six-degree-of-freedom navigation of visually presented three-dimensional structure. Although the technique depends only on the bulk translation and rotation of the operator's hand—so that its fingers may in principal be held in any pose desired—the present embodiment prefers a static configuration in which the index finger points away from the body; the thumb points toward the ceiling; and the middle finger points left-right. The three fingers thus describe (roughly, but with clearly evident intent) the three mutually orthogonal axes of a three-space coordinate system: thus ‘XYZ-hand’.

XYZ-hand navigation then proceeds with the hand, fingers in a pose as described above, held before the operator's body at a predetermined ‘neutral location’. Access to the three translational and three rotational degrees of freedom of a three-space object (or camera) is effected in the following natural way: left-right movement of the hand (with respect to the body's natural coordinate system) results in movement along the computational context's x-axis; up-down movement of the hand results in movement along the controlled context's y-axis; and forward-back hand movement (toward/away from the operator's body) results in z-axis motion within the context. Similarly, rotation of the operator's hand about the index finger leads to a ‘roll’ change of the computational context's orientation; ‘pitch’ and ‘yaw’ changes are effected analogously, through rotation of the operator's hand about the middle finger and thumb, respectively.

Note that while ‘computational context’ is used here to refer to the entity being controlled by the XYZ-hand method—and seems to suggest either a synthetic three-space object or camera—it should be understood that the technique is equally useful for controlling the various degrees of freedom of real-world objects: the pan/tilt/roll controls of a video or motion picture camera equipped with appropriate rotational actuators, for example. Further, the physical degrees of freedom afforded by the XYZ-hand posture may be somewhat less literally mapped even in a virtual domain: In the present embodiment, the XYZ-hand is also used to provide navigational access to large panoramic display images, so that left-right and up-down motions of the operator's hand lead to the expected left-right or up-down ‘panning’ about the image, but forward-back motion of the operator's hand maps to ‘zooming’ control.

In every case, coupling between the motion of the hand and the induced computational translation/rotation may be either direct (i.e. a positional or rotational offset of the operator's hand maps one-to-one, via some linear or nonlinear function, to a positional or rotational offset of the object or camera in the computational context) or indirect (i.e. positional or rotational offset of the operator's hand maps one-to-one, via some linear or nonlinear function, to a first or higher-degree derivative of position/orientation in the computational context; ongoing integration then effects a non-static change in the computational context's actual zero-order position/orientation). This latter means of control is analogous to use of a an automobile's ‘gas pedal’, in which a constant offset of the pedal leads, more or less, to a constant vehicle speed.

The ‘neutral location’ that serves as the real-world XYZ-hand's local six-degree-of-freedom coordinate origin may be established (1) as an absolute position and orientation in space (relative, say, to the enclosing room); (2) as a fixed position and orientation relative to the operator herself (e.g. eight inches in front of the body, ten inches below the chin, and laterally in line with the shoulder plane), irrespective of the overall position and ‘heading’ of the operator; or (3) interactively, through deliberate secondary action of the operator (using, for example, a gestural command enacted by the operator's ‘other’ hand, said command indicating that the XYZ-hand's present position and orientation should henceforth be used as the translational and rotational origin).

It is further convenient to provide a ‘detent’ region (or ‘dead zone’) about the XYZ-hand's neutral location, such that movements within this volume do not map to movements in the controlled context.

Other poses may included:

[|∥∥:vx] is a flat hand (thumb parallel to fingers) with palm facing down and fingers forward.

[|∥∥:x̂] is a flat hand with palm facing forward and fingers toward ceiling.

[|∥∥:-x] is a flat hand with palm facing toward the center of the body (right if left hand, left if right hand) and fingers forward.

[̂̂̂̂:-x] is a single-hand thumbs-up (with thumb pointing toward ceiling).

[̂̂̂|-:-x] is a mime gun pointing forward.

### Two Hand Combination

An embodiment contemplates single hand commands and poses, as well as two-handed commands and poses. FIG. 5 illustrates examples of two hand combinations and associated notation in an embodiment. Reviewing the notation of the first example, “full stop” reveals that it comprises two closed fists. The “snapshot” example has the thumb and index finger of each hand extended, thumbs pointing toward each other, defining a goal post shaped frame. The “rudder and throttle start position” is fingers and thumbs pointing up palms facing the screen.

### Orientation Blends

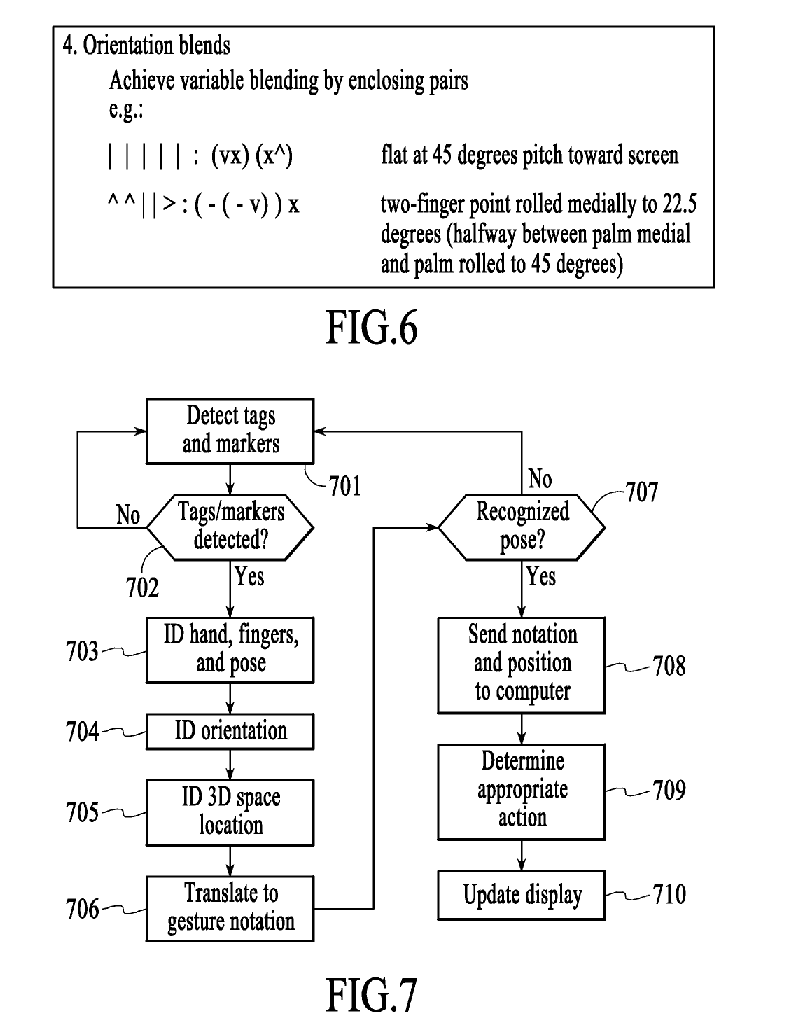

FIG. 6 illustrates an example of an orientation blend in an embodiment. In the example shown the blend is represented by enclosing pairs of orientation notations in parentheses after the finger pose string. For example, the first command shows finger positions of all pointing straight. The first pair of orientation commands would result in the palms being flat toward the display and the second pair has the hands rotating to a 45 degree pitch toward the screen. Although pairs of blends are shown in this example, any number of blends is contemplated.

### Example Commands

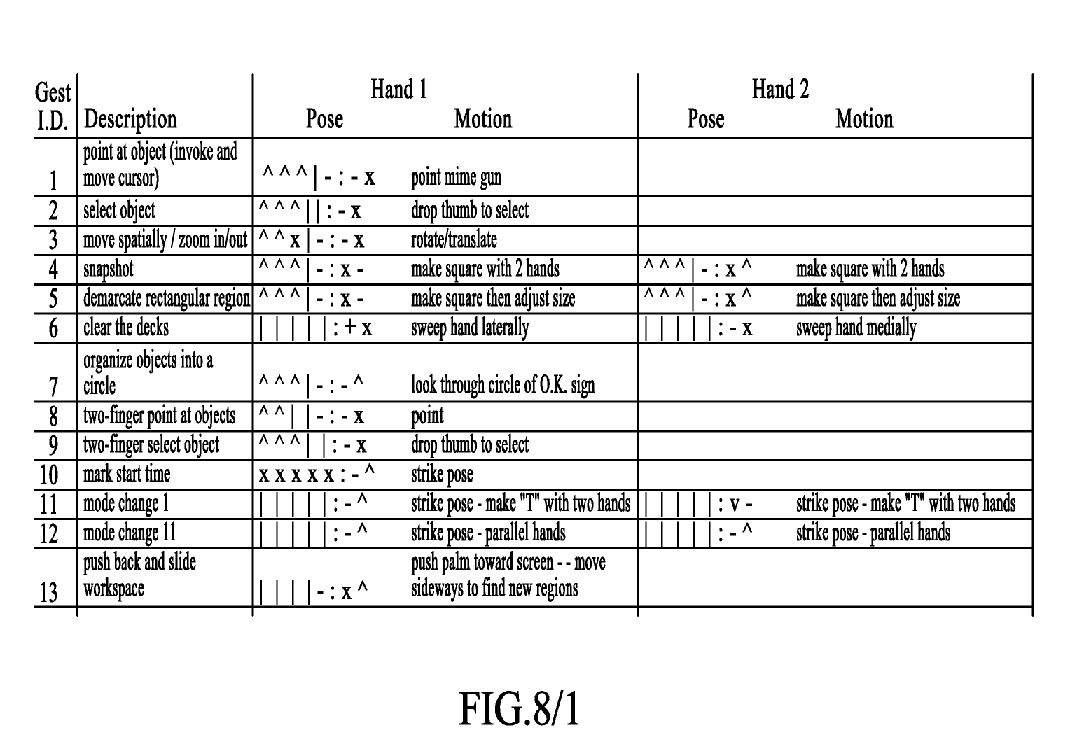

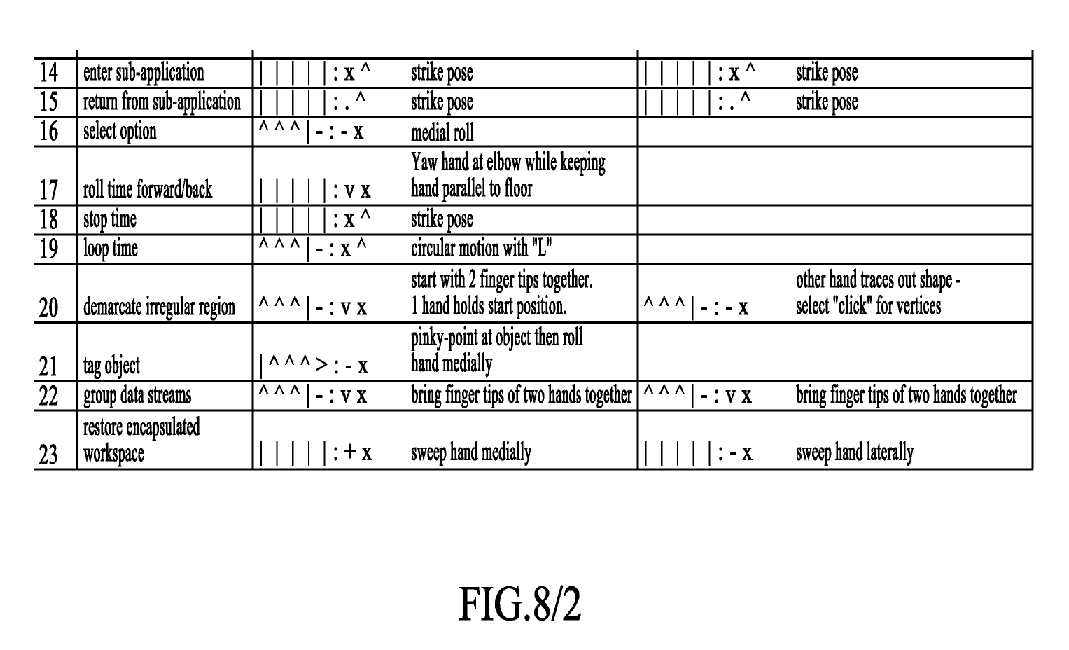

FIGS. 8/1 and 8/2 illustrates a number of possible commands that may be used, under an embodiment. Although portions of the description herein are to controlling a cursor on a display, the embodiment is not limited to that activity. In fact, the embodiment has great application in manipulating any and all data and portions of data on a screen, as well as the state of the display. For example, the commands may be used to take the place of video controls during play back of video media. The commands may be used to pause, fast forward, rewind, and the like. In addition, commands may be implemented to zoom in or zoom out of an image, to change the orientation of an image, to pan in any direction, and the like. The embodiment may also be used in lieu of menu commands such as open, close, save, and the like. In other words, any commands or activity that can be imagined can be implemented with hand gestures.

### Operation

FIG. 7 is a flow diagram illustrating system operation, under an embodiment. At 701 the detection system detects the markers and tags. At 702 it is determined if the tags and markers are detected. If not, the system returns to 701. If the tags and markers are detected at 702, the system proceeds to 703. At 703 the system identifies the hand, fingers and pose from the detected tags and markers. At 704 the system identifies the orientation of the pose. At 705 the system identifies the three dimensional spatial location of the hand or hands that are detected. (Please note that any or all of 703, 704, and 705 may be combined).

At 706 the information is translated to the gesture notation described above. At 707 it is determined if the pose is valid. This may be accomplished via a simple string comparison using the generated notation string. If the pose is not valid, the system returns to 701. If the pose is valid, the system sends the notation and position information to the computer at 708. At 709 the computer determines the appropriate action to take in response to the gesture and updates the display accordingly at 710.

In one embodiment, 701-705 are accomplished by the on-camera processor. In other embodiments, the processing can be accomplished by the system computer if desired.

### Parsing and Translation

The system is able to “parse” and “translate” a stream of low-level gestures recovered by an underlying system, and turn those parsed and translated gestures into a stream of command or event data that can be used to control a broad range of computer applications and systems. These techniques and algorithms may be embodied in a system consisting of computer code that provides both an engine implementing these techniques and a platform for building computer applications that make use of the engine's capabilities.

One embodiment is focused on enabling rich gestural use of human hands in computer interfaces, but is also able to recognize gestures made by other body parts (including, but not limited to arms, torso, legs and the head), as well as non-hand physical tools of various kinds, both static and articulating, including but not limited to calipers, compasses, flexible curve approximators, and pointing devices of various shapes. The markers and tags may be applied to items and tools that may be carried and used by the operator as desired.

The system described here incorporates a number of innovations that make it possible to build gestural systems that are rich in the range of gestures that can be recognized and acted upon, while at the same time providing for easy integration into applications.

The gestural parsing and translation system in one embodiment comprises:

1) a compact and efficient way to specify (encode for use in computer programs) gestures at several different levels of aggregation:
a. a single hand's “pose” (the configuration and orientation of the parts of the hand relative to one another) a single hand's orientation and position in three-dimensional space.
b. two-handed combinations, for either hand taking into account pose, position or both.
c. multi-person combinations; the system can track more than two hands, and so more than one person can cooperatively (or competitively, in the case of game applications) control the target system.
d. sequential gestures in which poses are combined in a series; we call these “animating” gestures.
e. “grapheme” gestures, in which the operator traces shapes in space.

2) a programmatic technique for registering specific gestures from each category above that are relevant to a given application context.

3) algorithms for parsing the gesture stream so that registered gestures can be identified and events encapsulating those gestures can be delivered to relevant application contexts.

The specification system (1), with constituent elements (1a) to (1f), provides the basis for making use of the gestural parsing and translating capabilities of the system described here.

A single-hand “pose” is represented as a string of
i) relative orientations between the fingers and the back of the hand,

ii) quantized into a small number of discrete states.

Using relative joint orientations allows the system described here to avoid problems associated with differing hand sizes and geometries. No “operator calibration” is required with this system. In addition, specifying poses as a string or collection of relative orientations allows more complex gesture specifications to be easily created by combining pose representations with further filters and specifications.

Using a small number of discrete states for pose specification makes it possible to specify poses compactly as well as to ensure accurate pose recognition using a variety of underlying tracking technologies (for example, passive optical tracking using cameras, active optical tracking using lighted dots and cameras, electromagnetic field tracking, etc).

Gestures in every category (1a) to (1f) may be partially (or minimally) specified, so that non-critical data is ignored. For example, a gesture in which the position of two fingers is definitive, and other finger positions are unimportant, may be represented by a single specification in which the operative positions of the two relevant fingers is given and, within the same string, “wild cards” or generic “ignore these” indicators are listed for the other fingers.

All of the innovations described here for gesture recognition, including but not limited to the multi-layered specification technique, use of relative orientations, quantization of data, and allowance for partial or minimal specification at every level, generalize beyond specification of hand gestures to specification of gestures using other body parts and “manufactured” tools and objects.

The programmatic techniques for “registering gestures” (2), consist of a defined set of Application Programming Interface calls that allow a programmer to define which gestures the engine should make available to other parts of the running system.

These API routines may be used at application set-up time, creating a static interface definition that is used throughout the lifetime of the running application. They may also be used during the course of the run, allowing the interface characteristics to change on the fly. This real-time alteration of the interface makes it possible to,

i) build complex contextual and conditional control states,

ii) to dynamically add hysterisis to the control environment, and

iii) to create applications in which the user is able to alter or extend the interface vocabulary of the running system itself.

Algorithms for parsing the gesture stream (3) compare gestures specified as in (1) and registered as in (2) against incoming low-level gesture data. When a match for a registered gesture is recognized, event data representing the matched gesture is delivered up the stack to running applications.

Efficient real-time matching is desired in the design of this system, and specified gestures are treated as a tree of possibilities that are processed as quickly as possible.

In addition, the primitive comparison operators used internally to recognize specified gestures are also exposed for the applications programmer to use, so that further comparison (flexible state inspection in complex or compound gestures, for example) can happen even from within application contexts.

Recognition “locking” semantics are an innovation of the system described here. These semantics are implied by the registration API (2) (and, to a lesser extent, embedded within the specification vocabulary (1)). Registration API calls include,

i) “entry” state notifiers and “continuation” state notifiers, and

ii) gesture priority specifiers.

If a gesture has been recognized, its “continuation” conditions take precedence over all “entry” conditions for gestures of the same or lower priorities. This distinction between entry and continuation states adds significantly to perceived system usability.

The system described here includes algorithms for robust operation in the face of real-world data error and uncertainty. Data from low-level tracking systems may be incomplete (for a variety of reasons, including occlusion of markers in optical tracking, network drop-out or processing lag, etc).

Missing data is marked by the parsing system, and interpolated into either “last known” or “most likely” states, depending on the amount and context of the missing data.

If data about a particular gesture component (for example, the orientation of a particular joint) is missing, but the “last known” state of that particular component can be analyzed as physically possible, the system uses this last known state in its real-time matching.

Conversely, if the last known state is analyzed as physically impossible, the system falls back to a “best guess range” for the component, and uses this synthetic data in its real-time matching.

The specification and parsing systems described here have been carefully designed to support “handedness agnosticism,” so that for multi-hand gestures either hand is permitted to satisfy pose requirements.

### Coincident Virtual/Display and Physical Spaces

The system can provide an environment in which virtual space depicted on one or more display devices (“screens”) is treated as coincident with the physical space inhabited by the operator or operators of the system. An embodiment of such an environment is described here. This current embodiment includes three projector-driven screens at fixed locations, is driven by a single desktop computer, and is controlled using the gestural vocabulary and interface system described herein. Note, however, that any number of screens are supported by the techniques being described; that those screens may be mobile (rather than fixed); that the screens may be driven by many independent computers simultaneously; and that the overall system can be controlled by any input device or technique.

The interface system described in this disclosure should have a means of determining the dimensions, orientations and positions of screens in physical space. Given this information, the system is able to dynamically map the physical space in which these screens are located (and which the operators of the system inhabit) as a projection into the virtual space of computer applications running on the system. As part of this automatic mapping, the system also translates the scale, angles, depth, dimensions and other spatial characteristics of the two spaces in a variety of ways, according to the needs of the applications that are hosted by the system.

This continuous translation between physical and virtual space makes possible the consistent and pervasive use of a number of interface techniques that are difficult to achieve on existing application platforms or that must be implemented piece-meal for each application running on existing platforms. These techniques include (but are not limited to):

1) Use of “literal pointing”—using the hands in a gestural interface environment, or using physical pointing tools or devices—as a pervasive and natural interface technique.

2) Automatic compensation for movement or repositioning of screens.

3) Graphics rendering that changes depending on operator position, for example simulating parallax shifts to enhance depth perception.

4) Inclusion of physical objects in on-screen display—taking into account real-world position, orientation, state, etc. For example, an operator standing in front of a large, opaque screen, could see both applications graphics and a representation of the true position of a scale model that is behind the screen (and is, perhaps, moving or changing orientation).

It is important to note that literal pointing is different from the abstract pointing used in mouse-based windowing interfaces and most other contemporary systems. In those systems, the operator must learn to manage a translation between a virtual pointer and a physical pointing device, and must map between the two cognitively.

By contrast, in the systems described in this disclosure, there is no difference between virtual and physical space (except that virtual space is more amenable to mathematical manipulation), either from an application or user perspective, so there is no cognitive translation required of the operator.

The closest analogy for the literal pointing provided by the embodiment described here is the touch-sensitive screen (as found, for example, on many ATM machines). A touch-sensitive screen provides a one to one mapping between the two-dimensional display space on the screen and the two-dimensional input space of the screen surface. In an analogous fashion, the systems described here provide a flexible mapping (possibly, but not necessarily, one to one) between a virtual space displayed on one or more screens and the physical space inhabited by the operator. Despite the usefulness of the analogy, it is worth understanding that the extension of this “mapping approach” to three dimensions, an arbitrarily large architectural environment, and multiple screens is non-trivial.

In addition to the components described herein, the system can also implement algorithms implementing a continuous, systems-level mapping (perhaps modified by rotation, translation, scaling or other geometrical transformations) between the physical space of the environment and the display space on each screen.

The system of an embodiment includes a rendering stack which takes the computational objects and the mapping and outputs a graphical representation of the virtual space.

The system of an embodiment includes an input events processing stack which takes event data from a control system (in the current embodiment both gestural and pointing data from the system and mouse input) and maps spatial data from input events to coordinates in virtual space. Translated events are then delivered to running applications.

The system of an embodiment includes a “glue layer” allowing the system to host applications running across several computers on a local area network.

The embodiments described herein include a system comprising: a plurality of sensors in a vehicle, wherein the plurality of sensors image an object and output gesture data representing a gesture made by the object, wherein the gesture data is an instantaneous state of the object at a point in time in space, wherein the object comprises at least one of a hand and a finger of a user; a processor coupled to the plurality of sensors, the processor automatically detecting the gesture of the object from the gesture data, the detecting comprising extracting positions of the object, the detecting comprising recovering quantized poses and orientation vectors of the object, the detecting comprising translating the gesture data to a gesture signal; and a controller coupled to the processor and to a plurality of vehicle subsystems of the vehicle, the controller managing user interactions with the plurality of vehicle subsystems in response to the gesture signal.

The plurality of sensors of an embodiment is positioned to view a passenger compartment of the vehicle.

The plurality of sensors of an embodiment comprises a plurality of cameras.

The plurality of cameras of an embodiment comprises a stereo-vision system.

The gesture data of an embodiment comprises a three-dimensional data point cloud representative of the object.

A resolved depth accuracy of data points in the three-dimensional data point cloud of an embodiment is approximately 1 millimeter (mm).

The positions of the object of an embodiment comprise position of a hand.

The positions of the object of an embodiment comprise position of a set of fingers.

The quantized poses of the object of an embodiment comprise quantized poses of at least one hand.

The orientation vectors of the object of an embodiment comprise continuous orientation vectors of at least one hand.

The orientation vectors of the object of an embodiment comprise continuous orientation vectors of a set of fingers.

The translating of an embodiment comprises translating information of the gesture to a gesture notation.

The gesture notation of an embodiment represents a gesture vocabulary, and the gesture signal comprises communications of the gesture vocabulary.

The gesture vocabulary of an embodiment represents in textual form instantaneous pose states of kinematic linkages of the object.

The gesture vocabulary of an embodiment represents in textual form an orientation of kinematic linkages of the object.

The gesture vocabulary of an embodiment represents in textual form a combination of orientations of kinematic linkages of the object.

The gesture vocabulary of an embodiment includes a string of characters that represent a state of kinematic linkages of the object.

The system of an embodiment comprises a feedback device coupled to the processor, the feedback device providing to the user indications corresponding to the gesture.

The indications of an embodiment comprise an interpretation of the gesture.

The indications of an embodiment comprise an effect realized on the plurality of vehicle subsystems in response to the gesture.

The feedback device of an embodiment is a visual device.

The feedback device of an embodiment is an aural device.

The feedback device of an embodiment is an audio-visual device.

The feedback device of an embodiment is a head-up display of the vehicle.

The feedback device of an embodiment is a pixel-based display of the vehicle.

The feedback device of an embodiment is at least one color-changing lighted indicator.

The feedback device of an embodiment is a tactile display.

The controller of an embodiment manages the user interactions using a first interactive mode, the first interactive mode comprising controlling the interactions with the plurality of vehicle subsystems in response to the gesture, wherein the gesture comprises finger motions of the user.

The gesture of an embodiment comprises a grip-and-extend-again motion of two fingers of a hand, wherein the controller cycles through a plurality of control elements of the vehicle subsystems in response to the gesture, wherein each control element allows the user to control a parameter of a vehicle subsystem.

The gesture of an embodiment comprises a grip-and-extend-again motion of a finger of a hand of the user, wherein the controller incrementally changes a setting of the parameter in response to the gesture.

The gesture of an embodiment comprises holding a first finger down and extending a second finger, wherein the controller changes a setting of the parameter at a constant rate in response to the gesture.

The gesture of an embodiment comprises extension of at least one finger of a first hand of the user, wherein the processor activates the controller in response to the gesture.

Hands of the user of an embodiment remain in contact with a guidance mechanism of the vehicle during the gesture.

The at least one finger of an embodiment is at least one of an index finger, a middle finger, and a thumb of the user.

The gesture of an embodiment comprises a grip-and-extend-again motion of two fingers of the first hand, wherein the controller cycles through a plurality of control modes of the vehicle subsystems in response to the gesture, wherein each control mode of the plurality of control modes corresponds to a vehicle subsystem.

The gesture of an embodiment comprises a grip-and-extend-again motion of two fingers of a second hand, wherein the controller cycles through a plurality of control options of each control mode in response to the gesture, wherein each control option of the plurality of control options corresponds to a vehicle subsystem.

The gesture of an embodiment comprises a grip-and-extend-again motion of a finger of a hand of the user, wherein the controller controls a setting of a control in response to the gesture.

The gesture of an embodiment comprises a grip-and-extend-again motion of a first finger of a hand of the user, wherein the controller incrementally changes the setting by stepping the setting in a first direction in response to the gesture.

The gesture of an embodiment comprises a grip-and-extend-again motion of a second finger of a hand of the user, wherein the controller incrementally changes the setting by stepping the setting in a second direction in response to the gesture.

The gesture of an embodiment comprises holding the first finger down and extending the second finger, wherein the controller changes the setting at a constant rate in response to the gesture.

The system of an embodiment comprises a graphical display coupled to the processor, the graphical display providing to the user indications corresponding to the gesture, wherein the gesture controls position of a display element on the graphical display.

The finger motions of an embodiment effect non-linear selection of a control element of the vehicle subsystems via the display element, wherein each control element allows the user to control a parameter of a vehicle subsystem.

The gesture of an embodiment comprises extension of at least one finger of a first hand of the user, wherein the processor activates the controller and causes the display element to be displayed in response to the gesture.

The gesture of an embodiment comprises relative movement of a finger tip, wherein the processor controls movement of the display element on the graphical display in response to the relative movement of the finger tip.

Interface graphics of the display of an embodiment are selected by proximity of the display element, wherein the display element is a pointer.

The interface graphics of an embodiment correspond to control elements of the vehicle subsystems, wherein an interface graphic of each control element allows the user to control a parameter of a vehicle subsystem.

The gesture of an embodiment comprises a grip-and-extend-again motion of a finger of a hand of the user, wherein the controller changes a setting of the parameter via the interface graphic in response to the gesture.

The gesture of an embodiment comprises holding a first finger down and extending a second finger, wherein the controller changes a setting of the parameter via the interface graphic in response to the gesture.

The display element of an embodiment comprises a toggle switch icon, wherein the gesture comprises a grip-and-extend-again motion of a finger of a hand of the user, wherein the gesture controls a setting of the toggle switch.

The display element of an embodiment comprises a slider icon, wherein the gesture comprises holding a first finger down and extending a second finger, wherein the controller changes a setting of the slider at a constant rate in response to the gesture.

The display element of an embodiment comprises a slider icon, wherein the gesture comprises a grip-and-extend-again motion of a finger of a hand of the user, wherein the controller incrementally changes a setting of the slider in response to the gesture.

The controller of an embodiment manages the user interactions using a second interactive mode, the second interactive mode comprising controlling the interactions with the plurality of vehicle subsystems in response to the gesture, wherein the gesture comprises hand motions and finger motions of the user.

The controller of an embodiment cycles through a plurality of control elements of the vehicle subsystems in response to the gesture, wherein each control element allows the user to control a parameter of a vehicle subsystem.

The gesture of an embodiment comprises a first finger of a hand extended in a first direction.

The gesture of an embodiment comprises a second finger of the hand extended in a second direction.

The gesture of an embodiment comprises a vertical orientation of a combination of the hand, the first finger and the second finger, wherein the vertical orientation places the hand, the first finger and the second finger in a gravity-aligned plane.

The gesture of an embodiment comprises a horizontal orientation of a combination of the hand, the first finger and the second finger, wherein the horizontal orientation places the hand, the first finger and the second finger in a gravity-perpendicular plane.

The gesture of an embodiment comprises a third finger of the hand extended in the first direction and approximately aligned with the first finger.

The second finger of an embodiment when extended is approximately perpendicular to the first finger.

The second finger of an embodiment when extended is approximately parallel to the first finger.

The gesture of an embodiment comprises the hand rotated into a position in which the first finger is pointing approximately medially.

The system of an embodiment comprises a graphical display coupled to the processor, the graphical display providing control to the user via the gesture, wherein the controller cycles through a plurality of control elements of the vehicle subsystems in response to the gesture, wherein each control element allows the user to control a parameter of a vehicle subsystem.

The gesture of an embodiment controls position of a display element on the graphical display.

The gesture of an embodiment comprises a first finger of a hand extended in a first direction.

The display element of an embodiment comprises a pointer, wherein the position of the pointer is controlled by at least one of movement and aim of the first finger.

The gesture of an embodiment controls a selection of a control element when the pointer is placed within a control element using the aim of the first finger and a second finger of the hand is moved from a first position to a second position, wherein the first position is extended approximately perpendicular to the first finger and the second position is extended approximately parallel to the first finger.

The gesture of an embodiment comprises aiming the first finger at a position off the graphical display, wherein the controller presents a menu list.

The gesture of an embodiment comprises aiming the first finger at a menu item and moving the second finger to the first position, wherein the controller selects the menu item as an active control element.

The gesture of an embodiment comprises a vertical orientation of a combination of the hand and at least one finger of the hand, wherein the vertical orientation places the hand, the first finger and the second finger in a gravity-aligned plane, wherein the controller presents a first set of control elements.

The gesture of an embodiment comprises a horizontal orientation of a combination of the hand and at least one finger of the hand, wherein the horizontal orientation places the hand, the first finger and the second finger in a gravity-perpendicular plane, wherein the controller presents a second set of control elements different from the first set of control elements.

The vehicle subsystems of an embodiment comprise at least one of climate control devices, multi-function display devices, audio devices, radio devices, digital audio devices, telephones, navigation devices, cruise control devices, autopilot devices, automated guidance devices, and networked devices.

The plurality of sensors of an embodiment comprises a plurality of time-of-flight depth-sensing cameras.

The plurality of sensors of an embodiment comprises a plurality of structured light three-dimensional sensors.

The embodiments described herein include a system comprising: a plurality of sensors, wherein the plurality of sensors image an object and output gesture data representing a gesture, wherein the gesture data is an instantaneous state of the object at a point in time in space, wherein the object comprises at least one of a hand and a finger; and a processor coupled to the plurality of sensors, the processor automatically detecting the gesture of the object from the gesture data, the detecting comprising extracting positions of the object, the detecting comprising recovering quantized poses and orientation vectors of the object, the detecting comprising translating the gesture data to a gesture signal and using the gesture signal to control a vehicle subsystem coupled to the processor.

The embodiments described herein include a system comprising: a plurality of sensors installed in a vehicle, wherein the plurality of sensors image an object and output gesture data representing a gesture made by the object, wherein the gesture data is an instantaneous state of the object at a point in time in space; a processor coupled to the plurality of sensors, the processor automatically detecting the gesture of the object from the gesture data and translating the gesture data to a gesture signal; a controller coupled to the processor and to vehicle subsystems of the vehicle, the controller controlling the vehicle subsystems in response to the gesture signal; and a feedback device coupled to the processor, the feedback device providing at least one of visual and audio feedback corresponding to the gesture.

The embodiments described herein include a method comprising: receiving an image of an object via a plurality of sensors in a vehicle and outputting gesture data representing a gesture made by the object, wherein the gesture data is an instantaneous state of the object at a point in time in space, wherein the object comprises at least one of a hand and a finger of a user; automatically detecting the gesture of the object from the gesture data by extracting positions of the object, recovering quantized poses and orientation vectors of the object, and translating the gesture data to a gesture signal; and managing user interactions with a plurality of vehicle subsystems in response to the gesture signal.

The method of an embodiment comprises positioning the plurality of sensors to view a passenger compartment of the vehicle, wherein the plurality of sensors comprises a plurality of cameras.

The gesture data of an embodiment comprises a three-dimensional data point cloud representative of the object.

The positions of the object of an embodiment comprise position of a hand.

The positions of the object of an embodiment comprise position of a set of fingers.

The quantized poses of the object of an embodiment comprise quantized poses of at least one hand.

The orientation vectors of the object of an embodiment comprise continuous orientation vectors of at least one hand.

The orientation vectors of the object of an embodiment comprise continuous orientation vectors of a set of fingers.

The translating of an embodiment comprises translating information of the gesture to a gesture notation, wherein the gesture notation represents a gesture vocabulary, and the gesture signal comprises communications of the gesture vocabulary.

The gesture vocabulary of an embodiment represents in textual form instantaneous pose states of kinematic linkages of the object.

The gesture vocabulary of an embodiment represents in textual form an orientation of kinematic linkages of the object.

The gesture vocabulary of an embodiment includes a string of characters that represent a state of kinematic linkages of the object.

The method of an embodiment comprises providing to the user indications corresponding to the gesture, wherein the indications comprise at least one of an interpretation of the gesture and an effect realized on the plurality of vehicle subsystems in response to the gesture.

The managing of the user interactions of an embodiment comprises using a first interactive mode, the first interactive mode comprising controlling the interactions with the plurality of vehicle subsystems in response to the gesture, wherein the gesture comprises finger motions of the user.

The gesture of an embodiment comprises a grip-and-extend-again motion of two fingers of a hand, wherein the managing user interactions comprises cycling through a plurality of control elements of the vehicle subsystems in response to the gesture, wherein each control element allows the user to control a parameter of a vehicle subsystem.

The gesture of an embodiment comprises a grip-and-extend-again motion of a finger of a hand of the user, wherein the managing user interactions comprises incrementally changing a setting of the parameter in response to the gesture.

The gesture of an embodiment comprises holding a first finger down and extending a second finger, wherein the managing user interactions comprises changing a setting of the parameter at a constant rate in response to the gesture.

Hands of the user of an embodiment remain in contact with a guidance mechanism of the vehicle during the gesture.

The method of an embodiment comprises providing to the user indications corresponding to the gesture, wherein the gesture controls position of a display element on the graphical display.

The finger motions of an embodiment effect non-linear selection of a control element of the vehicle subsystems via the display element, wherein each control element allows the user to control a parameter of a vehicle subsystem.

The gesture of an embodiment comprises relative movement of a finger tip, wherein the managing user interactions comprises controlling movement of the display element on the graphical display in response to the relative movement of the finger tip.

The method of an embodiment comprises selecting interface graphics of the display by proximity of the display element, wherein the display element is a pointer.

The interface graphics of an embodiment correspond to control elements of the vehicle subsystems, wherein an interface graphic of each control element allows the user to control a parameter of a vehicle subsystem.

The managing of the user interactions of an embodiment comprises using a second interactive mode, the second interactive mode comprising controlling the interactions with the plurality of vehicle subsystems in response to the gesture, wherein the gesture comprises hand motions and finger motions of the user.

The method of an embodiment comprises cycling through a plurality of control elements of the vehicle subsystems in response to the gesture, wherein each control element allows the user to control a parameter of a vehicle subsystem.

The gesture of an embodiment comprises a first finger of a hand extended in a first direction.

The gesture of an embodiment comprises a second finger of the hand extended in a second direction.

The gesture of an embodiment comprises a vertical orientation of a combination of the hand, the first finger and the second finger, wherein the vertical orientation places the hand, the first finger and the second finger in a gravity-aligned plane.

The gesture of an embodiment comprises a horizontal orientation of a combination of the hand, the first finger and the second finger, wherein the horizontal orientation places the hand, the first finger and the second finger in a gravity-perpendicular plane.

The gesture of an embodiment comprises a third finger of the hand extended in the first direction and approximately aligned with the first finger.

The second finger of an embodiment when extended is approximately perpendicular to the first finger.

The second finger of an embodiment when extended is approximately parallel to the first finger.

The gesture of an embodiment comprises the hand rotated into a position in which the first finger is pointing approximately medially.

The method of an embodiment comprises providing a display output that provides control to a user via the gesture, wherein the managing user interactions comprises cycling through a plurality of control elements of the vehicle subsystems in response to the gesture, wherein each control element allows the user to control a parameter of a vehicle subsystem.

The gesture of an embodiment controls position of a display element on the display output.

The gesture of an embodiment comprises a first finger of a hand extended in a first direction.

The display element of an embodiment comprises a pointer, wherein the position of the pointer is controlled by at least one of movement and aim of the first finger.

The gesture of an embodiment controls a selection of a control element when the pointer is placed within a control element using the aim of the first finger and a second finger of the hand is moved from a first position to a second position, wherein the first position is extended approximately perpendicular to the first finger and the second position is extended approximately parallel to the first finger.

The gesture of an embodiment comprises aiming the first finger at a position off the graphical display, wherein the controller presents a menu list.

The gesture of an embodiment comprises aiming the first finger at a menu item and moving the second finger to the first position, wherein the controller selects the menu item as an active control element.

The gesture-based control systems and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

Communication paths couple the system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of gesture-based control is not intended to be exhaustive or to limit the systems and methods described to the precise form disclosed. While specific embodiments of, and examples for, the gesture-based control are described herein for illustrative purposes, various equivalent modifications are possible within the scope of other systems and methods, as those skilled in the relevant art will recognize. The teachings of the gesture-based control provided herein can be applied to other processing systems and methods, not only for the systems and methods described above.

The elements and acts of the various embodiments described above can be combined to provide further embodiments. These and other changes can be made to the gesture-based control in light of the above detailed description.

In general, in the following claims, the terms used should not be construed to limit the gesture-based control to the specific embodiments disclosed in the specification and the claims, but should be construed to include all systems that operate under the claims. Accordingly, the gesture-based control is not limited by the disclosure, but instead the scope of the gesture-based control is to be determined entirely by the claims.

While certain aspects of the gesture-based control are presented below in certain claim forms, the inventors contemplate the various aspects of the gesture-based control in any number of claim forms. Accordingly, the inventors reserve the right to add additional claims after filing the application to pursue such additional claim forms for other aspects of the gesture-based control.

What is claimed is:

1. A system comprising:
a plurality of sensors in a vehicle, wherein the plurality of sensors image an object and output gesture data representing a gesture made by the object, wherein the gesture data is an instantaneous state of the object at a point in time in space, wherein the object comprises at least one of a hand and a finger of a user;
a processor coupled to the plurality of sensors, the processor automatically detecting the gesture of the object from the gesture data, the detecting comprising extracting positions of the object, the detecting comprising recovering quantized poses and orientation vectors of the object, the detecting comprising translating the gesture data to a gesture signal; and
a controller coupled to the processor and to a plurality of vehicle subsystems of the vehicle, the controller managing user interactions with the plurality of vehicle subsystems in response to the gesture signal.

2. The system of claim 1, wherein the plurality of sensors are positioned to view a passenger compartment of the vehicle.

3. The system of claim 1, wherein the plurality of sensors comprise a plurality of cameras.

4. The system of claim 3, wherein the plurality of cameras comprise a stereo-vision system.

5. The system of claim 1, wherein the gesture data comprises a three-dimensional data point cloud representative of the object.

6. The system of claim 5, wherein a resolved depth accuracy of data points in the three-dimensional data point cloud is approximately 1 millimeter (mm).

7. The system of claim 1, wherein the positions of the object comprise position of a hand.

8. The system of claim 1, wherein the positions of the object comprise position of a set of fingers.

9. The system of claim 1, wherein the quantized poses of the object comprise quantized poses of at least one hand.

10. The system of claim 1, wherein the orientation vectors of the object comprise continuous orientation vectors of at least one hand.

11. The system of claim 1, wherein the orientation vectors of the object comprise continuous orientation vectors of a set of fingers.

12. The system of claim 1, wherein the translating comprises translating information of the gesture to a gesture notation.

13. The system of claim 12, wherein the gesture notation represents a gesture vocabulary, and the gesture signal comprises communications of the gesture vocabulary.

14. The system of claim 13, wherein the gesture vocabulary represents in textual form instantaneous pose states of kinematic linkages of the object.

15. The system of claim 13, wherein the gesture vocabulary represents in textual form an orientation of kinematic linkages of the object.

16. The system of claim 13, wherein the gesture vocabulary represents in textual form a combination of orientations of kinematic linkages of the object.

17. The system of claim 13, wherein the gesture vocabulary includes a string of characters that represent a state of kinematic linkages of the object.

18. The system of claim 1, comprising a feedback device coupled to the processor, the feedback device providing to the user indications corresponding to the gesture.

19. The system of claim 18, wherein the indications comprise an interpretation of the gesture.

20. The system of claim 18, wherein the indications comprise an effect realized on the plurality of vehicle subsystems in response to the gesture.

21. The system of claim 18, wherein the feedback device is a visual device.

22. The system of claim 18, wherein the feedback device is an aural device.

23. The system of claim 18, wherein the feedback device is an audio-visual device.

24. The system of claim 18, wherein the feedback device is a head-up display of the vehicle.

25. The system of claim 18, wherein the feedback device is a pixel-based display of the vehicle.

26. The system of claim 18, wherein the feedback device is at least one color-changing lighted indicator.

27. The system of claim 18, wherein the feedback device is a tactile display.

28. The system of claim 1, wherein the controller manages the user interactions using a first interactive mode, the first interactive mode comprising controlling the interactions with the plurality of vehicle subsystems in response to the gesture, wherein the gesture comprises finger motions of the user.

29. The system of claim 28, wherein the gesture comprises a grip-and-extend-again motion of two fingers of a hand, wherein the controller cycles through a plurality of control elements of the vehicle subsystems in response to the gesture, wherein each control element allows the user to control a parameter of a vehicle subsystem.

30. The system of claim 29, wherein the gesture comprises a grip-and-extend-again motion of a finger of a hand of the user, wherein the controller incrementally changes a setting of the parameter in response to the gesture.

31. The system of claim 29, wherein the gesture comprises holding a first finger down and extending a second finger, wherein the controller changes a setting of the parameter at a constant rate in response to the gesture.

32. The system of claim 28, wherein the gesture comprises extension of at least one finger of a first hand of the user, wherein the processor activates the controller in response to the gesture.

33. The system of claim 32, wherein hands of the user remain in contact with a guidance mechanism of the vehicle during the gesture.

34. The system of claim 32, wherein the at least one finger is at least one of an index finger, a middle finger, and a thumb of the user.

35. The system of claim 32, wherein the gesture comprises a grip-and-extend-again motion of two fingers of the first hand, wherein the controller cycles through a plurality of control modes of the vehicle subsystems in response to the gesture, wherein each control mode of the plurality of control modes corresponds to a vehicle subsystem.

36. The system of claim 35, wherein the gesture comprises a grip-and-extend-again motion of two fingers of a second hand, wherein the controller cycles through a plurality of control options of each control mode in response to the gesture, wherein each control option of the plurality of control options corresponds to a vehicle subsystem.

37. The system of claim 36, wherein the gesture comprises a grip-and-extend-again motion of a finger of a hand of the user, wherein the controller controls a setting of a control in response to the gesture.

38. The system of claim 37, wherein the gesture comprises a grip-and-extend-again motion of a first finger of a hand of the user, wherein the controller incrementally changes the setting by stepping the setting in a first direction in response to the gesture.

39. The system of claim 38, wherein the gesture comprises a grip-and-extend-again motion of a second finger of a hand of the user, wherein the controller incrementally changes the setting by stepping the setting in a second direction in response to the gesture.

40. The system of claim 39, wherein the gesture comprises holding the first finger down and extending the second finger, wherein the controller changes the setting at a constant rate in response to the gesture.

41. The system of claim 28, comprising a graphical display coupled to the processor, the graphical display providing to the user indications corresponding to the gesture, wherein the gesture controls position of a display element on the graphical display.

42. The system of claim 41, wherein the finger motions effect non-linear selection of a control element of the vehicle subsystems via the display element, wherein each control element allows the user to control a parameter of a vehicle subsystem.

43. The system of claim 42, wherein the gesture comprises extension of at least one finger of a first hand of the user, wherein the processor activates the controller and causes the display element to be displayed in response to the gesture.

44. The system of claim 43, wherein the gesture comprises relative movement of a finger tip, wherein the processor controls movement of the display element on the graphical display in response to the relative movement of the finger tip.

45. The system of claim 44, wherein interface graphics of the display are selected by proximity of the display element, wherein the display element is a pointer.

46. The system of claim 45, wherein the interface graphics correspond to control elements of the vehicle subsystems, wherein an interface graphic of each control element allows the user to control a parameter of a vehicle subsystem.

47. The system of claim 46, wherein the gesture comprises a grip-and-extend-again motion of a finger of a hand of the user, wherein the controller changes a setting of the parameter via the interface graphic in response to the gesture.

48. The system of claim 46, wherein the gesture comprises holding a first finger down and extending a second finger, wherein the controller changes a setting of the parameter via the interface graphic in response to the gesture.

49. The system of claim 41, wherein the display element comprises a toggle switch icon, wherein the gesture comprises a grip-and-extend-again motion of a finger of a hand of the user, wherein the gesture controls a setting of the toggle switch.

50. The system of claim 41, wherein the display element comprises a slider icon, wherein the gesture comprises holding a first finger down and extending a second finger, wherein the controller changes a setting of the slider at a constant rate in response to the gesture.

51. The system of claim 41, wherein the display element comprises a slider icon, wherein the gesture comprises a grip-and-extend-again motion of a finger of a hand of the user, wherein the controller incrementally changes a setting of the slider in response to the gesture.

52. The system of claim 1, wherein the controller manages the user interactions using a second interactive mode, the second interactive mode comprising controlling the interactions with the plurality of vehicle subsystems in response to the gesture, wherein the gesture comprises hand motions and finger motions of the user.

53. The system of claim 52, wherein the controller cycles through a plurality of control elements of the vehicle subsystems in response to the gesture, wherein each control element allows the user to control a parameter of a vehicle subsystem.

54. The system of claim 52, wherein the gesture comprises a first finger of a hand extended in a first direction.

55. The system of claim 54, wherein the gesture comprises a second finger of the hand extended in a second direction.

56. The system of claim 55, wherein the gesture comprises a vertical orientation of a combination of the hand, the first finger and the second finger, wherein the vertical orientation places the hand, the first finger and the second finger in a gravity-aligned plane.

57. The system of claim 55, wherein the gesture comprises a horizontal orientation of a combination of the hand, the first finger and the second finger, wherein the horizontal orientation places the hand, the first finger and the second finger in a gravity-perpendicular plane.

58. The system of claim 55, wherein the gesture comprises a third finger of the hand extended in the first direction and approximately aligned with the first finger.

59. The system of claim 55, wherein the second finger when extended is approximately perpendicular to the first finger.

60. The system of claim 55, wherein the second finger when extended is approximately parallel to the first finger.

61. The system of claim 55, wherein the gesture comprises the hand rotated into a position in which the first finger is pointing approximately medially.

62. The system of claim 52, comprising a graphical display coupled to the processor, the graphical display providing control to the user via the gesture, wherein the controller cycles through a plurality of control elements of the vehicle subsystems in response to the gesture, wherein each control element allows the user to control a parameter of a vehicle subsystem.

63. The system of claim 62, wherein the gesture controls position of a display element on the graphical display.

64. The system of claim 63, wherein the gesture comprises a first finger of a hand extended in a first direction.

65. The system of claim 64, wherein the display element comprises a pointer, wherein the position of the pointer is controlled by at least one of movement and aim of the first finger.

66. The system of claim 65, wherein the gesture controls a selection of a control element when the pointer is placed within a control element using the aim of the first finger and a second finger of the hand is moved from a first position to a second position, wherein the first position is extended approximately perpendicular to the first finger and the second position is extended approximately parallel to the first finger.

67. The system of claim 66, wherein the gesture comprises aiming the first finger at a position off the graphical display, wherein the controller presents a menu list.

68. The system of claim 67, wherein the gesture comprises aiming the first finger at a menu item and moving the second finger to the first position, wherein the controller selects the menu item as an active control element.

69. The system of claim 62, wherein the gesture comprises a vertical orientation of a combination of the hand and at least one finger of the hand, wherein the vertical orientation places the hand, the first finger and the second finger in a gravity-aligned plane, wherein the controller presents a first set of control elements.

70. The system of claim 69, wherein the gesture comprises a horizontal orientation of a combination of the hand and at least one finger of the hand, wherein the horizontal orientation places the hand, the first finger and the second finger in a gravity-perpendicular plane, wherein the controller presents a second set of control elements different from the first set of control elements.

71. The system of claim 1, wherein the vehicle subsystems comprise at least one of climate control devices, multi-function display devices, audio devices, radio devices, digital audio devices, telephones, navigation devices, cruise control devices, autopilot devices, automated guidance devices, and networked devices.

72. The system of claim 1, wherein the plurality of sensors comprises a plurality of time-of-flight depth-sensing cameras.

73. The system of claim 1, wherein the plurality of sensors comprises a plurality of structured light three-dimensional sensors.

74. A system comprising:
a plurality of sensors, wherein the plurality of sensors image an object and output gesture data representing a gesture, wherein the gesture data is an instantaneous state of the object at a point in time in space, wherein the object comprises at least one of a hand and a finger; and
a processor coupled to the plurality of sensors, the processor automatically detecting the gesture of the object from the gesture data, the detecting comprising extracting positions of the object, the detecting comprising recovering quantized poses and orientation vectors of the object, the detecting comprising translating the gesture data to a gesture signal and using the gesture signal to control a vehicle subsystem coupled to the processor.

75. A system comprising:
a plurality of sensors installed in a vehicle, wherein the plurality of sensors image an object and output gesture data representing a gesture made by the object, wherein the gesture data is an instantaneous state of the object at a point in time in space;
a processor coupled to the plurality of sensors, the processor automatically detecting the gesture of the object from the gesture data and translating the gesture data to a gesture signal;
a controller coupled to the processor and to vehicle subsystems of the vehicle, the controller controlling the vehicle subsystems in response to the gesture signal; and
a feedback device coupled to the processor, the feedback device providing at least one of visual and audio feedback corresponding to the gesture.

76. A method comprising:
receiving an image of an object via a plurality of sensors in a vehicle and outputting gesture data representing a gesture made by the object, wherein the gesture data is an instantaneous state of the object at a point in time in space, wherein the object comprises at least one of a hand and a finger of a user;
automatically detecting the gesture of the object from the gesture data by extracting positions of the object, recovering quantized poses and orientation vectors of the object, and translating the gesture data to a gesture signal; and
managing user interactions with a plurality of vehicle subsystems in response to the gesture signal.

77. The method of claim 76, comprising positioning the plurality of sensors to view a passenger compartment of the vehicle, wherein the plurality of sensors comprises a plurality of cameras.

78. The method of claim 76, wherein the gesture data comprises a three-dimensional data point cloud representative of the object.

79. The method of claim 76, wherein the positions of the object comprise position of a hand.

80. The method of claim 76, wherein the positions of the object comprise position of a set of fingers.

81. The method of claim 76, wherein the quantized poses of the object comprise quantized poses of at least one hand.

82. The method of claim 76, wherein the orientation vectors of the object comprise continuous orientation vectors of at least one hand.

83. The method of claim 76, wherein the orientation vectors of the object comprise continuous orientation vectors of a set of fingers.

84. The method of claim 76, wherein the translating comprises translating information of the gesture to a gesture notation, wherein the gesture notation represents a gesture vocabulary, and the gesture signal comprises communications of the gesture vocabulary.

85. The method of claim 84, wherein the gesture vocabulary represents in textual form instantaneous pose states of kinematic linkages of the object.

86. The method of claim 84, wherein the gesture vocabulary represents in textual form an orientation of kinematic linkages of the object.

87. The method of claim 84, wherein the gesture vocabulary includes a string of characters that represent a state of kinematic linkages of the object.

88. The method of claim 76, comprising providing to the user indications corresponding to the gesture, wherein the indications comprise at least one of an interpretation of the gesture and an effect realized on the plurality of vehicle subsystems in response to the gesture.

89. The method of claim 76, wherein the managing of the user interactions comprises using a first interactive mode, the first interactive mode comprising controlling the interactions with the plurality of vehicle subsystems in response to the gesture, wherein the gesture comprises finger motions of the user.

90. The method of claim 89, wherein the gesture comprises a grip-and-extend-again motion of two fingers of a hand, wherein the managing user interactions comprises cycling through a plurality of control elements of the vehicle subsystems in response to the gesture, wherein each control element allows the user to control a parameter of a vehicle subsystem.

91. The method of claim 90, wherein the gesture comprises a grip-and-extend-again motion of a finger of a hand of the user, wherein the managing user interactions comprises incrementally changing a setting of the parameter in response to the gesture.

92. The method of claim 90, wherein the gesture comprises holding a first finger down and extending a second finger, wherein the managing user interactions comprises changing a setting of the parameter at a constant rate in response to the gesture.

93. The method of claim 89, wherein hands of the user remain in contact with a guidance mechanism of the vehicle during the gesture.

94. The method of claim 89, comprising providing to the user indications corresponding to the gesture, wherein the gesture controls position of a display element on the graphical display.

95. The method of claim 94, wherein the finger motions effect non-linear selection of a control element of the vehicle subsystems via the display element, wherein each control element allows the user to control a parameter of a vehicle subsystem.

96. The method of claim 95, wherein the gesture comprises relative movement of a finger tip, wherein the managing user interactions comprises controlling movement of the display element on the graphical display in response to the relative movement of the finger tip.

97. The method of claim 96, comprising selecting interface graphics of the display by proximity of the display element, wherein the display element is a pointer.

98. The method of claim 97, wherein the interface graphics correspond to control elements of the vehicle subsystems, wherein an interface graphic of each control element allows the user to control a parameter of a vehicle subsystem.

99. The method of claim 76, wherein the managing of the user interactions comprises using a second interactive mode, the second interactive mode comprising controlling the interactions with the plurality of vehicle subsystems in response to the gesture, wherein the gesture comprises hand motions and finger motions of the user.

100. The method of claim 99, comprising cycling through a plurality of control elements of the vehicle subsystems in response to the gesture, wherein each control element allows the user to control a parameter of a vehicle subsystem.

101. The method of claim 99, wherein the gesture comprises a first finger of a hand extended in a first direction.

102. The method of claim 101, wherein the gesture comprises a second finger of the hand extended in a second direction.

103. The method of claim 102, wherein the gesture comprises a vertical orientation of a combination of the hand, the first finger and the second finger, wherein the vertical orientation places the hand, the first finger and the second finger in a gravity-aligned plane.

104. The method of claim 102, wherein the gesture comprises a horizontal orientation of a combination of the hand, the first finger and the second finger, wherein the horizontal orientation places the hand, the first finger and the second finger in a gravity-perpendicular plane.

105. The method of claim 102, wherein the gesture comprises a third finger of the hand extended in the first direction and approximately aligned with the first finger.

106. The method of claim 102, wherein the second finger when extended is approximately perpendicular to the first finger.

107. The method of claim 102, wherein the second finger when extended is approximately parallel to the first finger.

108. The method of claim 102, wherein the gesture comprises the hand rotated into a position in which the first finger is pointing approximately medially.

109. The method of claim 99, comprising providing a display output that provides control to a user via the gesture, wherein the managing user interactions comprises cycling through a plurality of control elements of the vehicle subsystems in response to the gesture, wherein each control element allows the user to control a parameter of a vehicle subsystem.

110. The method of claim 109, wherein the gesture controls position of a display element on the display output.

111. The method of claim 110, wherein the gesture comprises a first finger of a hand extended in a first direction.

112. The method of claim 111, wherein the display element comprises a pointer, wherein the position of the pointer is controlled by at least one of movement and aim of the first finger.

113. The method of claim 112, wherein the gesture controls a selection of a control element when the pointer is placed within a control element using the aim of the first finger and a second finger of the hand is moved from a first position to a second position, wherein the first position is extended approximately perpendicular to the first finger and the second position is extended approximately parallel to the first finger.

114. The method of claim 113, wherein the gesture comprises aiming the first finger at a position off the graphical display, wherein the controller presents a menu list.

115. The method of claim 114, wherein the gesture comprises aiming the first finger at a menu item and moving the second finger to the first position, wherein the controller selects the menu item as an active control element.
